(19) United States
(12) Patent Application Publication
(10) Pub. No.: US 2019/0366523 A1
(43) Pub. Date: Dec. 5, 2019

(54) MANIPULATING A LOCK RING FOR A WHEEL

(71) Applicant: KAL TIRE, Vernon (CA)

(72) Inventors: Clayton Wilford Russell MCMUNN, Lake Country (CA); Jan Peter NILSSON, Kelowna (CA); Rodrigo Cristian Reyes BARRAZA, Antofagasta (CL); Roberto Lourdes Jimenez RETAMAL, Antofagasta (CL); Mario Hugo Gomez ALCAYAGA, Antofagasta (CL)

(73) Assignee: KAL TIRE, Vernon, BC (CA)

(21) Appl. No.: 16/487,275

(22) PCT Filed: Feb. 23, 2018
(86) PCT No.: PCT/CA2018/050206

§ 371 Date: Aug. 20, 2019

(30) Foreign Application Priority Data
Feb. 23, 2017 (CA) 2959015

(51) Int. Cl. B25B 27/20; B25B 5/14; B60B 31/04; B60B 25/14

(52) U.S. Cl. CPC B25B 27/20; B25B 5/14; B60B 2340/52; B60B 25/14; B60B 31/04

(57) ABSTRACT

Methods for manipulating, positioning, and removing a lock ring for a wheel are disclosed. Manipulating the lock ring for the wheel involves increasing a separation distance between a first fastener fastened to a first end of the lock ring and a second fastener fastened to a second end of the lock ring opposite the first end. Positioning the lock ring in a lock ring groove of the wheel involves causing a lock ring positioner to position the lock ring proximate the wheel before positioning the lock ring in the lock ring groove of the wheel. Removing the lock ring from the wheel involves receiving the lock ring in at least one catcher receptacle of a lock ring positioner after removing the lock ring from the wheel.

### FIELD

This disclosure relates generally to manipulating a lock ring for a wheel.

### RELATED ART

Some wheels, such as wheels of off-the-road vehicles or of haul trucks for example, can include one or more lock ring grooves to receive one or more lock rings that, when positioned in a lock ring groove of a wheel, may assist in retaining a tire on the wheel.

Such a lock ring may be resiliently deformable and shaped such that a non-deformed shape of the lock ring, in the absence of external deforming force, has a smaller diameter than a lock ring groove of a wheel. Such a lock ring must therefore be resiliently expanded from its non-deformed shape, positioned over the lock ring groove, and released so that the resilient tendency of the lock ring to have a smaller diameter than the lock ring groove holds the lock ring in the lock ring groove.

Such a lock ring may require significant force to be resiliently expanded from its non-deformed shape enough to be positioned over such a lock ring groove, and such a lock ring may store significant elastic potential energy when positioned in such a lock ring groove. Therefore, positioning such a lock ring in a lock ring groove of a wheel, and removing such a lock ring from such a lock ring groove, can be challenging and can be dangerous.

### SUMMARY

According to one embodiment, a method of manipulating a lock ring for a wheel involves increasing a separation distance between a first fastener fastened to a first end of the lock ring and a second fastener fastened to a second end of the lock ring opposite the first end.

The method may further involve fastening the first and second fasteners to the first and second ends respectively of the lock ring.

Fastening the first fastener to the first end of the lock ring may involve clamping the first fastener to the first end of the lock ring.

Fastening the second fastener to the second end of the lock ring may involve clamping the second fastener to the second end of the lock ring.

Fastening the first fastener to the first end of the lock ring may involve positioning a retaining surface of the first fastener against an end surface of the first end of the lock ring.

Fastening the second fastener to the second end of the lock ring may involve positioning a retaining surface of the second fastener against an end surface of the second end of the lock ring.

Increasing the separation distance may involve causing motion of a ratchet to transfer force to the first and second fasteners.

The method may further involve guiding motion of the first and second fasteners relative to each other in a generally axial direction of the lock ring.

The method may further involve restricting a range of motion of the first and second fasteners relative to each other in the generally axial direction of the lock ring.

The method may further involve decreasing the separation distance between the first and second fasteners after increasing the separation distance, and positioning the lock ring in a lock ring groove of the wheel while decreasing the separation distance.

The method may further involve causing a lock ring positioner to position the lock ring proximate the wheel before positioning the lock ring in the lock ring groove of the wheel.

According to another embodiment, a method of positioning a lock ring in a lock ring groove of a wheel involves causing a lock ring positioner to position the lock ring proximate the wheel before positioning the lock ring in the lock ring groove of the wheel.

Causing the lock ring lifter to position the lock ring proximate the wheel may involve supporting the lock ring in a generally vertical orientation while allowing the lock ring to be rotated about a generally horizontal axis of the lock ring.

The method may further involve maintaining the separation distance after increasing the separation distance, and removing the lock ring from the wheel while maintaining the separation distance.

The method may further involve receiving the lock ring in at least one catcher receptacle of a lock ring positioner after removing the lock ring from the wheel.

According to another embodiment, a method of removing a lock ring from a wheel involves receiving the lock ring in at least one catcher receptacle of a lock ring positioner after removing the lock ring from the wheel.

The method may further involve aligning the at least one catcher receptacle relative to the wheel before receiving the lock ring in the at least one catcher receptacle.

Aligning the at least one catcher receptacle relative to the wheel may involve positioning at least one alignment surface against a portion of the wheel.

Positioning the at least one alignment surface against the portion of the wheel may involve positioning at least one roller against the portion of the wheel.

Positioning the at least one alignment surface against the portion of the wheel may involve positioning the at least one alignment surface against an inner surface of the wheel.

The method may further involve moving at least a portion of the lock ring positioner generally horizontally to move the lock ring generally horizontally.

The method may further involve moving at least a portion of the lock ring positioner generally vertically to move the lock ring generally vertically.

According to another embodiment, an apparatus for manipulating a lock ring for a wheel includes a first fastening means for fastening to a first end of the lock ring, a second fastening means for fastening to a second end of the lock ring opposite the first end of the lock ring, and a means for controlling a separation distance between the first and second fastening means when the first and second fastening means are fastened to the first and second ends respectively of the lock ring.

According to another embodiment, an apparatus for positioning a lock ring in a lock ring groove of a wheel includes a means for supporting the lock ring, and a means for moving the means for supporting to position the lock ring proximate the wheel before positioning the lock ring in the lock ring groove of the wheel.

According to another embodiment, an apparatus for removing a lock ring from a wheel includes a means for receiving the lock ring after removing the lock ring from the wheel, and a means for moving the means for receiving proximate the wheel to receive the lock ring when the lock ring is removed from the wheel.

The apparatus for removing a lock ring from a wheel may further include a means for supporting the lock ring, and a means for moving the means for supporting to position the lock ring proximate the wheel before positioning the lock ring in the lock ring groove of the wheel.

According to another embodiment, a kit includes the apparatus for manipulating a lock ring for a wheel as described above and at least one of the apparatus for positioning a lock ring in a lock ring groove of a wheel and either of the apparatuses for removing a lock ring from a wheel as described above.

According to another embodiment, there is provided use of any of the apparatuses as described above to position a lock ring in a lock ring groove of a wheel.

According to another embodiment, there is provided use of any of the apparatuses as described above to remove a lock ring from a wheel.

According to another embodiment, a system includes the apparatus for manipulating a lock ring for a wheel as described above and at least one of the apparatus for positioning a lock ring in a lock ring groove of a wheel as described above and either of the apparatuses for removing a lock ring from a wheel as described above.

According to another embodiment, there is provided use of the system to position a lock ring in a lock ring groove of a wheel.

According to another embodiment, there is provided use of the system to remove a lock ring from a wheel.

According to another embodiment, an apparatus for manipulating a lock ring for a wheel includes a first fastener configured to be fastened to a first end of the lock ring, a second fastener configured to be fastened to a second end of the lock ring opposite the first end of the lock ring, and a spreader coupled to the first and second fasteners and configured to increase a separation distance between the first and second fasteners when the first and second fasteners are fastened to the first and second ends respectively of the lock ring.

The first fastener may include a clamp configured to clamp the first end of the lock ring to fasten the first fastener to the first end of the lock ring.

The second fastener may include a clamp configured to clamp the second end of the lock ring to fasten the second fastener to the second end of the lock ring.

The first fastener may include a retaining surface configured to be positioned against an end surface of the first end of the lock ring when the first fastener is fastened to the first end of the lock ring.

The second fastener may include a retaining surface configured to be positioned against an end surface of the second end of the lock ring when the second fastener is fastened to the second end of the lock ring.

The spreader may include a linear translator configured to separate the first and second fasteners generally linearly from each other to increase the separation distance between the first and second fasteners.

The spreader may include a ratchet configured to transfer force to the first and second fasteners to increase the separation distance between the first and second fasteners.

The first fastener may be rotatable relative to the spreader generally about a first radial axis of the lock ring and the second fastener may be rotatable relative to the spreader generally about a second radial axis of the lock ring to permit the first and second fasteners to move relative to each other in a generally axial direction of the lock ring.

Rotation of the first fastener relative to the spreader may be restricted to restrict a range of motion of the first and second fasteners relative to each other in the generally axial direction of the lock ring.

Rotation of the second fastener relative to the spreader may be restricted to restrict a range of motion of the first and second fasteners relative to each other in the generally axial direction of the lock ring.

The spreader may be further configured to allow the separation distance between the first and second fasteners to decrease to position the lock ring in a lock ring groove of the wheel while decreasing the separation distance.

According to another embodiment, an apparatus for positioning a lock ring relative to a wheel includes at least one receptacle configured to hold the lock ring, wherein the at least one receptacle is movable proximate the wheel.

The least one receptacle may include at least one support receptacle configured to support the lock ring to position the lock ring in a lock ring groove of a wheel, and the at least one support receptacle may be movable to position the lock ring proximate the wheel before positioning the lock ring in the lock ring groove of the wheel.

The at least one support receptacle may be configured to support the lock ring in a generally vertical orientation while allowing the lock ring to be rotated about a generally horizontal axis of the lock ring.

The least one receptacle may include at least one catcher receptacle configured to receive the lock ring after removing the lock ring from the wheel, and the at least one catcher receptacle may be movable proximate the wheel to receive the lock ring when the lock ring is removed from the wheel.

The apparatus may further include at least one alignment surface positionable against a portion of the wheel to align the at least one catcher receptacle relative to the wheel before receiving the lock ring in the at least one catcher receptacle.

The apparatus may further include at least one roller comprising the at least one alignment surface.

The at least one receptacle may be movable generally vertically to move the lock ring generally vertically when the at least one receptacle holds the lock ring.

The at least one receptacle may be movable generally horizontally to move the lock ring generally horizontally when the at least one receptacle holds the lock ring.

According to another embodiment, a kit includes any one of the apparatuses for manipulating a lock ring for a wheel as described above and any one the apparatuses for positioning a lock ring relative to a wheel as described above.

According to another embodiment, there is provided use of any one of the apparatuses as described above to position a lock ring in a lock ring groove of a wheel.

According to another embodiment, there is provided use of any one of the apparatuses as described above to remove a lock ring from a wheel.

According to another embodiment, a system includes any one of the apparatuses for manipulating a lock ring for a wheel as described above and any one the apparatuses for positioning a lock ring relative to a wheel as described above.

According to another embodiment, there is provided use of the system to position a lock ring in a lock ring groove of a wheel.

According to another embodiment, there is provided use of the system to remove a lock ring from a wheel.

Other aspects and features will become apparent to those ordinarily skilled in the art upon review of the following description of illustrative embodiments in conjunction with the accompanying figures.

### BRIEF DESCRIPTION OF THE DRAWINGS

FIG. 1 is a rear perspective view of a lock ring according to one embodiment, and of an apparatus according to one embodiment for manipulating the lock ring.

FIG. 2 is an elevation view of the lock ring of FIG. 1 and of an apparatus according to another embodiment for manipulating the lock ring.

FIG. 3 is an enlarged perspective view of first and second ends of the lock ring of FIG. 1, and of the apparatus of FIG. 2.

FIG. 4 is a partial exploded perspective view of the apparatus of FIG. 2.

FIG. 5 is a partial assembled perspective view of the apparatus of FIG. 2.

FIG. 6 is a front perspective view of the lock ring of FIG. 1, and of the apparatus of FIG. 1 with first and second catcher arms according to one embodiment.

FIG. 7 is an enlarged perspective view of a catcher receptacle of the second catcher arm of FIG. 6.

FIG. 8 is a side elevation view of the apparatus of FIG. 1 with the second catcher arm of FIG. 6 proximate a wheel shown partially cut away according to one embodiment.

FIG. 9 is an enlarged side elevation view of the apparatus of FIG. 1 with the second catcher arm of FIG. 6 proximate the wheel of FIG. 8 again shown partially cut away.

FIG. 10 is a front perspective view of the apparatus of FIG. 1 configured for storage according to one embodiment.

FIG. 11 is a rear perspective view of a lock ring according to another embodiment, and of an apparatus according to another embodiment for manipulating the lock ring.

FIG. 12 is a front view of a support bar of the apparatus of FIG. 11.

FIG. 13 is a perspective view of a support receptacle of the apparatus of FIG. 11.

FIG. 14 is a front perspective view of a catcher arm of the apparatus of FIG. 11.

FIG. 15 is a side elevation view of a roller of the apparatus of FIG. 11.

### DETAILED DESCRIPTION

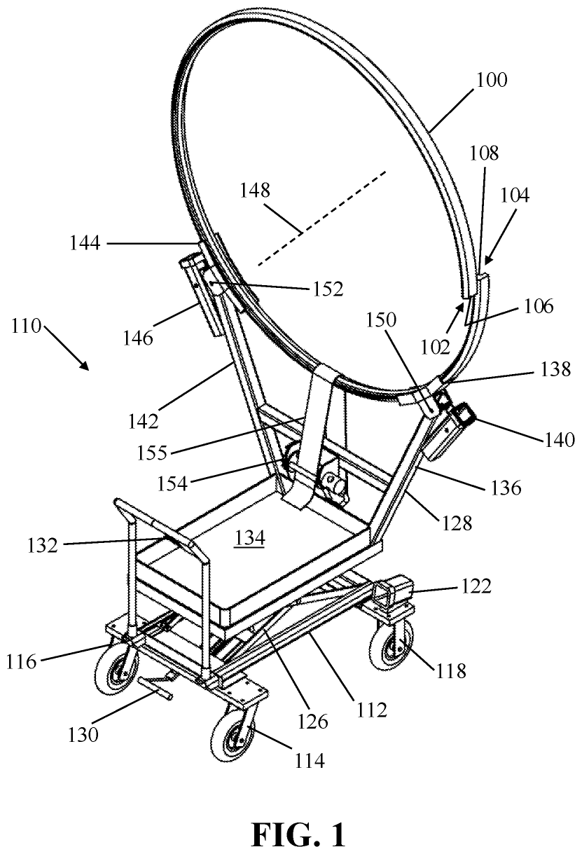

Referring to FIG. 1, a lock ring 100 for a wheel according to one embodiment is a generally circular split ring having a first end shown generally at 102 and a second end shown generally at 104 and opposite the first end 102. In this context, “generally circular” refers to a ring that may not be perfectly circular, but that may function substantially similarly to a circular ring. More generally, “generally” herein contemplates variations that may or may not be described herein and that may function substantially similar to those described herein. On the first end 102, the lock ring 100 has a first generally planar end surface 106 extending generally radially and axially relative to the lock ring 100, and on the second end 104, the lock ring 100 has a second generally planar end surface 108 extending generally radially and axially relative to the lock ring 100. The lock ring 100 is resiliently deformable and shaped to have a non-deformed shape in the absence of external deforming force as shown in FIG. 1. In the non-deformed shape, the first end 102 and the second end 104 partially overlap each other and are spaced apart from each other generally axially relative to the lock ring 100, although alternative embodiments may have other non-deformed shapes.

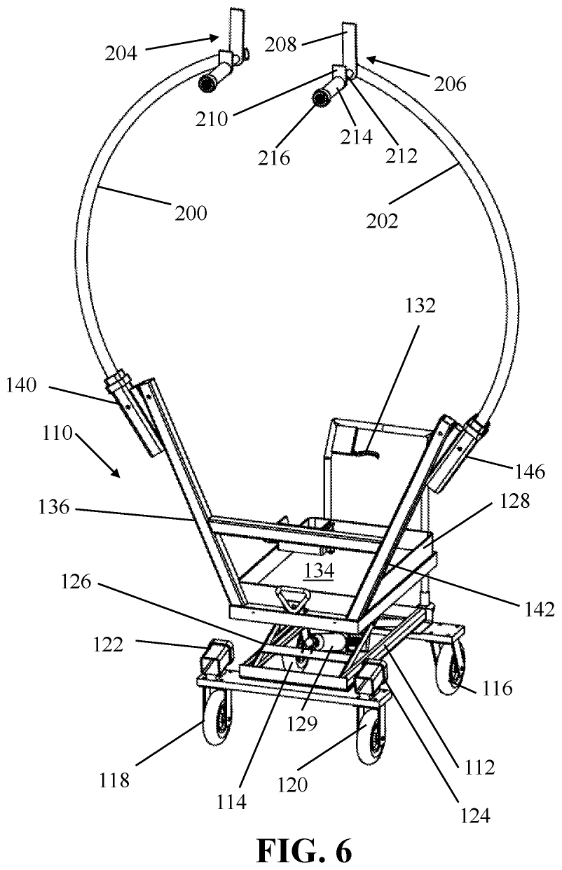

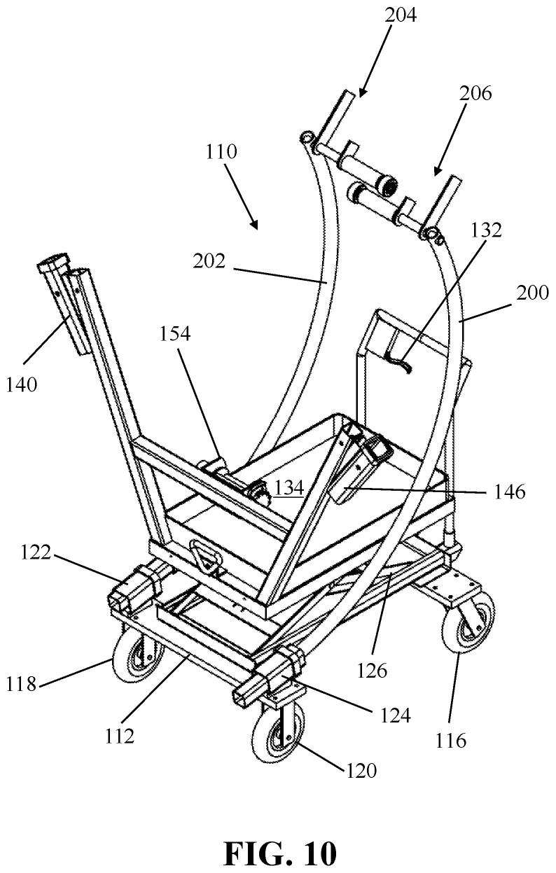

An apparatus according to one embodiment for manipulating the lock ring 100 is shown generally at 110. The apparatus 110 includes a base 112 that may be supported by caster wheels, such as rear caster wheels 114 and 116 and front rear caster wheels 118 and 120 (shown in FIGS. 6, 8, and 10) in the embodiment shown, to permit the base 112 and thus the apparatus 110 to move generally horizontally on a generally horizontal surface. Hard, compact, and/or level surfaces may be preferable. In some embodiments, one or more brakes (for example on the front rear caster wheels 118 and 120) may be manually applied, for example, to prevent generally horizontal movement of the base 112 and thus of the apparatus 110 on such a generally horizontal surface. Such brakes may be applied when the apparatus 110 is not in use or at other times described below, for example. In the embodiment shown, the rear caster wheels 114 and 116 may swivel to allow the base 112 and thus the apparatus 110 to move in different generally horizontal directions, and the front rear caster wheels 118 and 120 may be fixed relative to the base 112. In alternative embodiments, the base 112 and thus the apparatus 110 may be supported in other ways, and may move generally horizontally in other ways. The base also includes first and second storage receptacles 122 and 124 (shown in FIGS. 6 and 10) that may be used in storage as described below.

In the embodiment shown, the apparatus 110 also includes a hydraulic scissor lift 126 that movably supports a lock ring support body 128 relative to the base 112. The hydraulic scissor lift 126 may include a hydraulic cylinder 129 (shown in FIG. 6) to move the hydraulic scissor lift 126. A foot pump 130 may actuate the hydraulic cylinder 129 to increase a generally vertical height of the lock ring support body 128 relative to the base 112, and a lever 132 may decrease the generally vertical height of the lock ring support body 128 relative to the base 112. The lock ring support body 128 may be fully lowered when not in use, and one or more brakes on one or more of the caster wheels 114, 116, 118, and 120 may be applied when adjusting the generally vertical height of the lock ring support body 128 relative to the base 112. In alternative embodiments, the lock ring support body 128 may be supported in other ways, and may move generally vertically in other ways.

In the embodiments shown, the lock ring support body 128 may include: a lifting table or table 134; a first lock ring support 136 including a first support receptacle 138 and a first catch arm receptacle 140; and a second lock ring support 142 including a second support receptacle 144 and a second catch arm receptacle 146. As shown in FIG. 1, the first and second support receptacles 138 and 144 may support the lock ring 100 generally vertically while allowing the lock ring 100 to be rotated (manually or otherwise) about a generally horizontal axis 148 of the lock ring. The first support receptacle 138 may be hinged to the first lock ring support 136 at a first hinge 150, and the second support receptacle 144 may be hinged to the second lock ring support 142 at a second hinge 152, to accommodate different diameters of lock rings. A winch 154 may be attached to the lock ring support body 128 and may be configured to tighten a strap 155 over a portion of the lock ring 100 to secure the lock ring 100 in the first and second support receptacles 138 and 144, for example during movement of the apparatus 110, although one or both of the winch 154 and the strap 155 may differ or be omitted in alternative embodiments. More generally, in alternative embodiments, the lock ring support body 128 may support one or more lock rings in other ways.

The first and second support receptacles 138 and 144 may support the lock ring 100 relative to the lock ring support body 128 such that movement of the lock ring support body 128 causes movement of the lock ring 100. For example, moving the base 112, and thus the apparatus 110 and the lock ring support body 128, generally horizontally on the caster wheels 114, 116, 118, and 120 causes corresponding generally horizontal movement of the lock ring 100 when the lock ring 100 is supported in the first and second support receptacles 138 and 144 as shown in FIG. 1. Further, generally vertical movement of the lock ring support body 128 relative to the base 112 causes corresponding generally vertical movement of the lock ring 100 when the lock ring 100 is supported in the first and second support receptacles 138 and 144 as shown in FIG. 1.

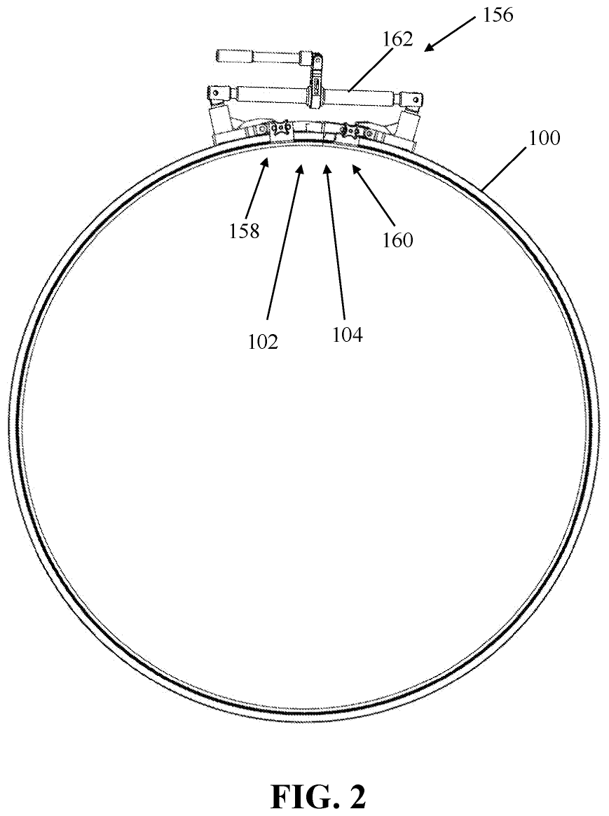

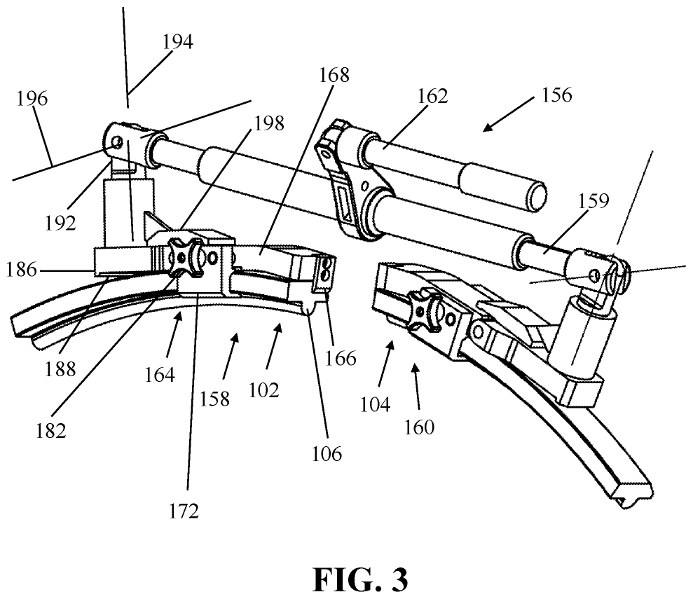

Referring to FIGS. 2 and 3, an apparatus according to another embodiment for manipulating the lock ring 100 is shown generally at 156. The apparatus 156 includes a first fastener shown generally at 158 that may be fastened to the first end 102 of the lock ring 100, and a second fastener shown generally at 160 that may be fastened to the second end 104 of the lock ring 100. Herein, “fastened to an end” does not necessarily refer to fastened at an end boundary, but rather includes fastened to an end region to function substantially as described herein. The apparatus 156 also includes a spreader 162, which in the embodiment shown is a ratchet that may use a mechanical advantage, that may transfer a force to the first and second fasteners 158 and 160, and that may function as a linear translator to transfer a force to a lead screw 159 and from the lead screw to the first and second fasteners 158 and 160 to increase or decrease a separation distance, and more generally to control the separation distance, between the first and second fasteners 158 and 160. Alternative embodiments may include an additional or another spreader or spreaders that may increase and/or decrease the separation distance between the first and second fasteners 158 and 160 in other ways.

In some embodiments, the lock ring 100 may have a maximum separation distance of the first and second ends 102 and 104, and separation of the first and second ends 102 and 104 in excess of the maximum separation distance may be undesirable. The maximum separation distance may vary for different types of lock ring, and some examples of possible approximate maximum separation distances are below.

| | Approximate | Approximate |
|---|---|---|
| | Maximum Separation | Maximum Separation |
| Lock Ring Type | Distance (Inches) | Distance (Centimeters) |
| TOPY 63″ STD | 7.5 | 19 |
| TOPY 63″ MST | 7.5 | 19 |
| WEDGE | | |
| TOPY 57″ STD | 4.5 | 11.5 |

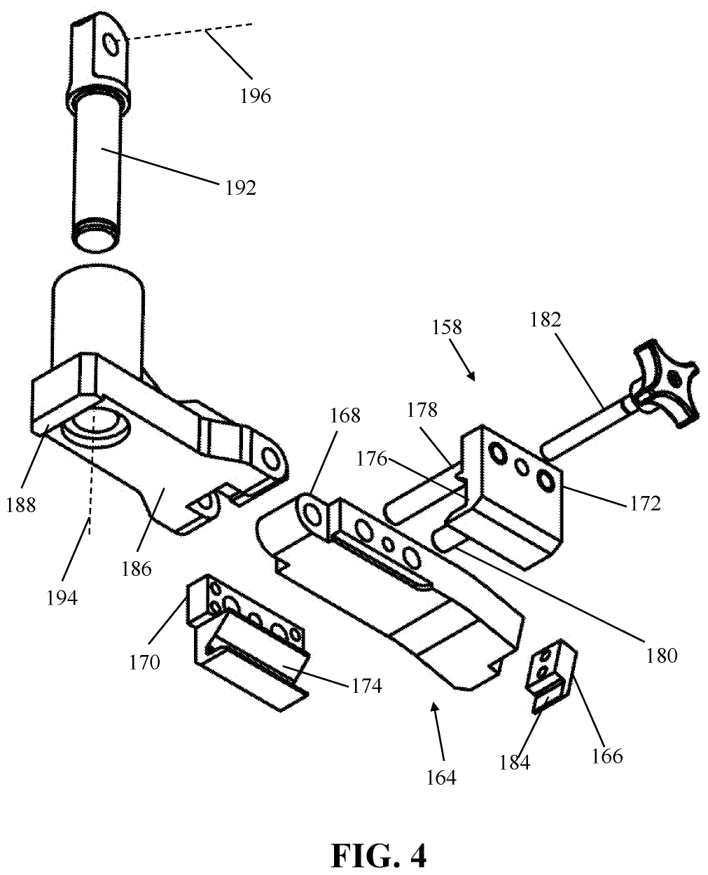

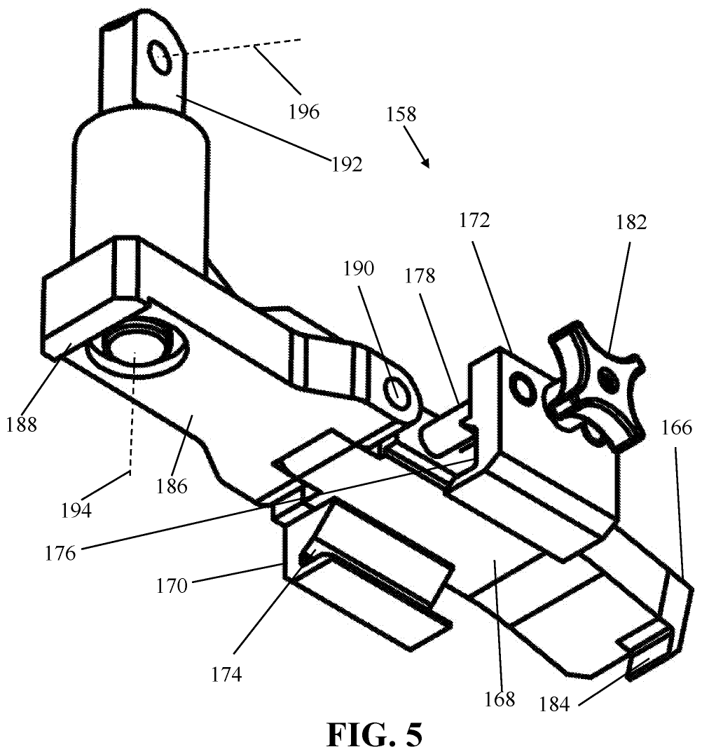

Referring to FIGS. 3-5, the first fastener 158 includes a clamp shown generally at 164 and a retaining body 166. The clamp 164 includes a central body 168 and lateral clamp bodies 170 and 172. The lateral clamp body 170 has a lock ring gripping surface 174, and the lateral clamp body 172 has a lock ring gripping surface 176. The lock ring gripping surfaces 174 and 176 may be shaped to complement lateral surfaces of the lock ring 100, and may differ for different lock rings. In some embodiments, lateral clamp bodies may be interchangeable so that lateral clamp bodies that are shaped to complement lateral surfaces of one type of lock ring may be substituted for different lateral clamp bodies that are shaped to complement lateral surfaces of a different type of lock ring.

One of the lateral clamp bodies 170 and 172 may be fixed to the central body 168, and the other of the lateral clamp bodies 170 and 172 may be movable relative to the central body 168 to allow the clamp 164 to open and close around an end of the lock ring 100. In the embodiment shown, the central body 168 and the lateral clamp bodies 170 and 172 may have aligned openings to receive alignment bodies 178 and 180 and a threaded fastener 182 so that the alignment bodies 178 and 180 may align the lateral clamp bodies 170 and 172 relative to the central body 168, and so that the movable one of the lateral clamp bodies 170 and 172 may slide along the alignment bodies 178 and 180 so that the threaded fastener 182, when tightened, may move the movable one of the lateral clamp bodies 170 and 172 to tighten the lock ring gripping surfaces 174 and 176 against lateral surfaces of the first end 102 of the lock ring 100. Further, a retaining surface 184 of the retaining body 166 may be positioned against the first generally planar end surface 106 as shown in FIG. 3 to prevent the first end 102 of the lock ring 100 from sliding along the lock ring gripping surfaces 174 and 176 when the lock ring gripping surfaces 174 and 176 are tightened against the lateral surfaces of the first end 102 of the lock ring 100, and when the first and second ends 102 and 104 of the lock ring 100 are being separated. Alternative embodiments may include other clamps, and more generally may include different fasteners that may or may not include clamps or retaining bodies as described above.

The central body 168 may be connected to a fastener support body 186, which may include a projection 188. A generally transverse hinge 190 connecting the central body 168 to the fastener support body 186 allows the projection 188 to be positionable on an outer surface of the lock ring 100 as shown in FIG. 3 and thus accommodates different diameters of lock rings. Alternative embodiments may include different fastener support bodies, that may or may not include such a projection, or alternative embodiments may omit the fastener support body 186.

A two-axis coupling 192 may couple the fastener support body 186 to the spreader 162 such that the fastener support body 186 may be rotatable relative to the spreader 162:
1. about an axis 194 that is generally radial relative to the lock ring 100 and that thus may guide movement of the first fastener 158 generally axially relative to the lock ring 100; and
2. about an axis 196 that is generally axial relative to the lock ring 100 and that thus may permit the central body 168 and thus the first fastener 158 to extend generally tangentially relative to the lock ring 100, thus accommodating different diameters of lock rings and different separation distances between the first and second fasteners 158 and 160.
   A projection 198 may limit rotation of the first fastener 158 relative to the spreader 162 within a range of rotation. An internal stop (not shown) in coupling 192 may limit a range of motion of the first fastener 158 generally axially relative to the lock ring 100.

The second fastener 160 may be substantially the same as the first fastener 158. Therefore, for example, rotation of the second fastener 160 relative to the spreader 162 may also be limited within a range of rotation, so that a range of motion of the first fastener 158 and of the second fastener 160 relative to each other and generally axially relative to the lock ring 100 may also be limited.

Accordingly, referring to FIGS. 1-6, in one embodiment positioning the lock ring 100 in a lock ring groove of a wheel with apparatus 110 may involve some or all of the following, and not necessarily in the following order:
1. fully lowering the lock ring support body 128;
2. removing first and second catch arms 200 and 202 (described below) from the lock ring support body 128;
3. attaching the first and second support receptacles 138 and 144 to the lock ring support body 128, for example with locking pins to attach the first and second support receptacles 138 and 144 to the lock ring support body 128;
4. applying one or more brakes on one or more of the caster wheels 114, 116, 118, and 120 to hold the apparatus 110 in position;
5. supporting the lock ring 100 in the first and second support receptacles 138 and 144;
6. when the lock ring 100 is supported in the first and second support receptacles 138 and 144, rotating the lock ring 100 about the generally horizontal axis 148 of the lock ring so that the first and second ends 102 and 104 of the lock ring 100 are in desired positions, such as 4:00 or 8:00 positions and not between the first and second support receptacles 138 and 144, for example;
7. tightening the strap 155, for example with the winch 154, to secure the lock ring 100 in the first and second support receptacles 138 and 144;
8. fastening the first fastener 158 to the first end 102 of the lock ring 100, which may involve one or both of:
   a. positioning the retaining surface 184 of the retaining body 166 against the first generally planar end surface 106, and
   b. tightening the threaded fastener 182 to tighten the lock ring gripping surfaces 174 and 176 against lateral surfaces of the first end 102 of the lock ring 100;
9. fastening the second fastener 160 to the second end 104 of the lock ring 100, which may be substantially the same as fastening the first fastener 158 to the first end 102 of the lock ring 100 as described above;
10. releasing the one or more brakes, and moving the apparatus 110, and thus the lock ring 100, generally horizontally on the caster wheels 114, 116, 118, and 120 such that the lock ring 100 is proximate the wheel;
11. applying one or more brakes on one or more of the caster wheels 114, 116, 118, and 120 to hold the apparatus 110 in position;
12. increasing a separation distance between the first and second fasteners 158 and 160, which may involve causing the ratchet, linear translator, or spreader 162 to transfer a force to the first and second fasteners 158 and 160;
13. maintaining the separation distance between the first and second fasteners 158 and 160;
14. while maintaining the separation distance between the first and second fasteners 158 and 160, positioning the lock ring 100 over the lock ring groove of the wheel, for example:
   a. when one or more brakes on one or more of the caster wheels 114, 116, 118, and 120 are applied, by adjusting a generally vertical height of the lock ring support body 128 relative to the base 112 to move the lock ring 100 generally vertically,
   b. when the one or more brakes are released, by moving the apparatus 110, and thus the lock ring 100, generally horizontally on the caster wheels 114, 116, 118, and 120, or
   c. by both;
15. adjusting a generally vertical height of the lock ring support body 128 relative to the base 112 to move the lock ring 100 generally vertically and proximate the wheel (in some embodiments this may involve moving the lock ring 100 generally vertically and into generally vertical alignment with the wheel such that the generally horizontal axis 148 of the lock ring 100 is substantially aligned with a corresponding horizontal axis of the wheel);
16. removing the strap 155;
17. when one or more brakes on one or more of the caster wheels 114, 116, 118, and 120 are applied, decreasing the separation distance between the first and second fasteners 158 and 160;
18. while decreasing the separation distance between the first and second fasteners 158 and 160, positioning the lock ring 100 in the lock ring groove of the wheel around the entire circumference of the wheel; and
19. after positioning the lock ring 100 in the lock ring groove of the wheel, releasing the brakes, removing the first fastener 158 from the first end 102 of the lock ring 100, and removing the second fastener 160 from the second end 104 of the lock ring 100.

In some embodiments, for example, the wheel may be a wheel of an off-the-road vehicle or of a haul truck, and the wheel may have a diameter from about 57 inches (or about 145 centimeters) to about 63 inches (or about 160 centimeters). Also, in some embodiments, the apparatus 156 may be unsuitable for lifting the lock ring 100, so the apparatus 110 and/or other tools may be used to lift the lock ring 100.

As indicated above, the lock ring 100 is shaped to have a non-deformed shape in the absence of external deforming force as shown in FIG. 1. The non-deformed shape of the lock ring 100 may have a smaller diameter than the lock ring groove of the wheel so that the resilient tendency of the lock ring 100 to have a smaller diameter than the lock ring groove may hold the lock ring in the lock ring groove.

Referring to FIG. 6, the first catch arm receptacle 140 may receive a first catch arm 200, and the second catch arm receptacle 146 may receive a second catch arm 202. In some embodiments, locking pins may attach the first and second catch arms 200 and 202 to the first and second catch arm receptacles 140 and 146 of the lock ring support body 128. Further, the first and second catch arm receptacles 140 and 146 and the first and second catch arms 200 and 202 may have complementary square-shaped cross-sections, or more generally complementary non-circular cross-sections, to maintain the first and second catch arms 200 and 202 in defined positions and orientations relative to the lock ring support body 128. Therefore, the first and second catch arm receptacles 140 and 146 may support the first and second catch arms 200 and 202 respectively relative to the lock ring support body 128 such that movement of the lock ring support body 128 causes movement of the first and second catch arms 200 and 202. For example, moving the base 112, and thus the apparatus 110 and the lock ring support body 128, generally horizontally on the caster wheels 114, 116, 118, and 120 causes corresponding generally horizontal movement of the first and second catch arms 200 and 202 when the first and second catch arms 200 and 202 are supported in the first and second catch arm receptacles 140 and 146 as shown in FIG. 6. Further, generally vertical movement of the lock ring support body 128 relative to the base 112 causes corresponding generally vertical movement of the first and second catch arms 200 and 202 when the first and second catch arms 200 and 202 are supported in the first and second catch arm receptacles 140 and 146 as shown in FIG. 6.

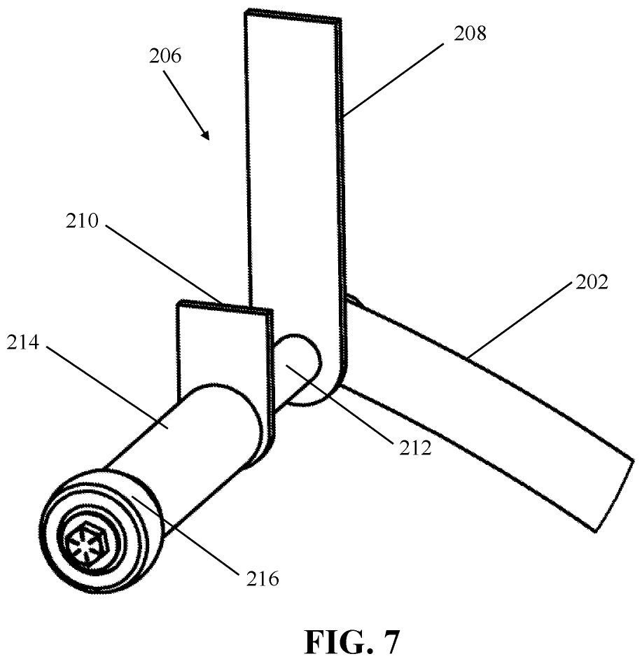

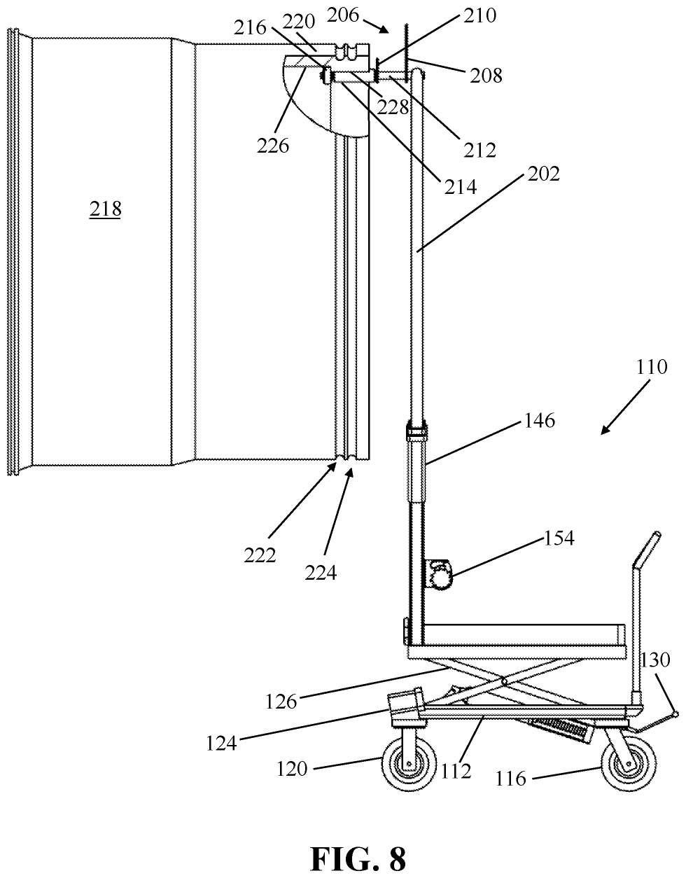

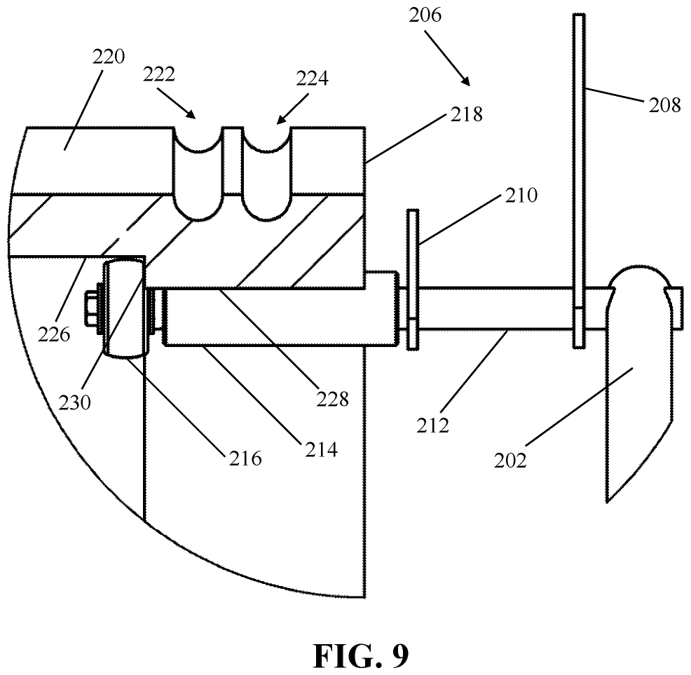

The first catch arm 200 may include a first catcher receptacle shown generally at 204, and the second catch arm 202 may include a second catcher receptacle shown generally at 206. Referring to FIGS. 7-9, the second catcher receptacle 206 may include guide plates 208 and 210 and a catch body 212 extending between the guide plates 208 and 210. Collectively, the guide plates 208 and 210 and the catch body 212 may receive, position, and/or hold a lock ring after the lock ring is removed from a lock ring groove of a wheel. Further, a roller 214 (which may be aluminum and may be knurled, for example) may extend away from the second catcher receptacle 206. Further, an end roller 216, which may be rubber, and which may have a diameter greater than a diameter of the roller 214, may be on an end of the roller 214 opposite the second catcher receptacle 206. One or more surfaces of the roller 214, of the end roller 216, or of both may be positioned against one or more surfaces of a wheel (as shown in FIGS. 8 and 9, for example) and may thus align the second catcher receptacle 206 relative to the wheel; and/or allow the first and second catcher receptacles 204 and 206 to center themselves on a top side of the wheel while being elevated against the top side of the wheel, for example to accommodate for any misalignment of the apparatus 110 relative to the wheel. Further, the end roller 216 may be received behind a surface of the wheel (as shown in FIGS. 8 and 9, for example) to prevent the second catcher receptacle 206 from separating from the wheel. The first catcher receptacle 204 may be substantially the same as the second catcher receptacle 206. In alternative embodiments, the lock ring support body 128 may support one or more catcher receptacles in other ways, and one or more catcher receptacles may differ in alternative embodiments.

Referring to FIGS. 8 and 9, a lock ring may be removed from a wheel 218, which may be a wheel of an off-the-road vehicle or of a haul truck, for example. In the embodiment shown, the wheel 218 has an outer peripheral surface 220, and a pair of lock ring grooves 222 and 224 that are in the outer peripheral surface 220 and sized to receive a lock ring, such as the lock ring 100 for example. Further, in the embodiment shown, the wheel 218 has a first generally cylindrical inner surface 226, a second generally cylindrical inner surface 228, and a generally annular inner surface 230 extending between the first and second generally cylindrical inner surfaces 226 and 228.

In one embodiment, removing a lock ring from one of the lock ring grooves 222 or 224 of the wheel 218 with apparatus 110 may involve some or all of the following, and not necessarily in the following order:
1. fully lowering the lock ring support body 128;
2. removing the first and second support receptacles 138 and 144 from the lock ring support body 128;
3. attaching the first and second catch arms 200 and 202 to the first and second catch arm receptacles 140 and 146 of the lock ring support body 128, for example with locking pins to attach the first and second catch arms 200 and 202 to the first and second catch arm receptacles 140 and 146 of the lock ring support body 128;
4. moving the apparatus 110, and thus the first and second catch arms 200 and 202, generally horizontally on the caster wheels 114, 116, 118, and 120 and proximate the wheel 218;
5. applying one or more brakes on one or more of the caster wheels 114, 116, 118, and 120 to hold the apparatus 110 in position;
6. adjusting a generally vertical height of the lock ring support body 128 relative to the base 112 to move the first and second catch arms 200 and 202 such that, for example:
   a. an outer surface of the roller 214 contacts the second generally cylindrical inner surface 228, and an outer surface of the end roller 216 contacts the generally annular inner surface 230, to align the second catcher receptacle 206 to the wheel 218, and/or
   b. the first catcher receptacle 204 is aligned to the wheel 218 in substantially the same way;
7. fastening the first and second fasteners 158 and 160 to first and second ends of the lock ring, for example as described above;
8. increasing a separation distance between the first and second fasteners 158 and 160, which may involve causing the ratchet, linear translator, or spreader 162 to transfer a force to the first and second fasteners 158 and 160;
9. maintaining the separation distance between the first and second fasteners 158 and 160;
10. while maintaining the separation distance between the first and second fasteners 158 and 160, removing the lock ring from one of the lock ring grooves 222 or 224 of the wheel 218; and
11. after removing the lock ring from the wheel 218, receiving the lock ring in the first and second catcher receptacles 204 and 206.

The lock ring may be removed from the lock ring groove using, for example, a lever, a pry-bar, or by another removing mechanism.

As shown in FIG. 10, the apparatus 110 may be stored by storing the first catch arm 200 in the second storage receptacle 124 and by storing the second catch arm 202 in the first storage receptacle 122.

In general, embodiments such as those described herein may facilitate manipulating a lock ring such as the lock ring 100. For example, the apparatus 156 may facilitate resiliently increasing a diameter of a lock ring to position the lock ring in a lock ring groove of a wheel and/or to remove a lock ring from a lock ring groove of a wheel, for example as described above. Further, the apparatus 110 may facilitate holding, positioning, and/or receiving a lock ring while positioning the lock ring in a lock ring groove of a wheel and/or while removing a lock ring from a lock ring groove of a wheel, for example as described above. Embodiments such as the apparatus 156:
1. may be configured for positioning a lock ring in a lock ring groove of a wheel by removing the first and second catch arms 200 and 202 and by attaching the first and second support receptacles 138 and 144 to the lock ring support body 128; and
2. may be configured for removing a lock ring from a lock ring groove of a wheel by removing the first and second support receptacles 138 and 144 from the lock ring support body 128 and by attaching the first and second catch arms 200 and 202 to the first and second catch arm receptacles 140 and 146 of the lock ring support body 128;
   so that embodiments such as the apparatus 156 may be converted to one of different but potentially related purposes of positioning a lock ring in a lock ring groove of a wheel and removing a lock ring from a lock ring groove of a wheel.

Commercial embodiments may include kits or systems including one or more apparatuses such as those described above, and apparatuses, kits, and systems such as those described above may be offered commercially for use in positioning a lock ring in a lock ring groove of a wheel and/or removing a lock ring from a lock ring groove of a wheel, for example as described above.

Embodiments such as those described herein may hold a lock ring in a resiliently deformed position controllably, for example by controlling the separation distance between the first and second fasteners 158 and 160 as described above and/or by restricting the range of motion of the first fastener 158 and of the second fastener 160 relative to each other and generally axially relative to the lock ring 100, while positioning a lock ring in a lock ring groove of a wheel and/or while removing a lock ring from a lock ring groove of a wheel, and such controllable holding of a lock ring in a resiliently deformed position as described herein may require less human effort, may be less challenging, and/or may be less dangerous when compared to other ways of positioning a lock ring in a lock ring groove of a wheel and/or removing a lock ring from a lock ring groove of a wheel.

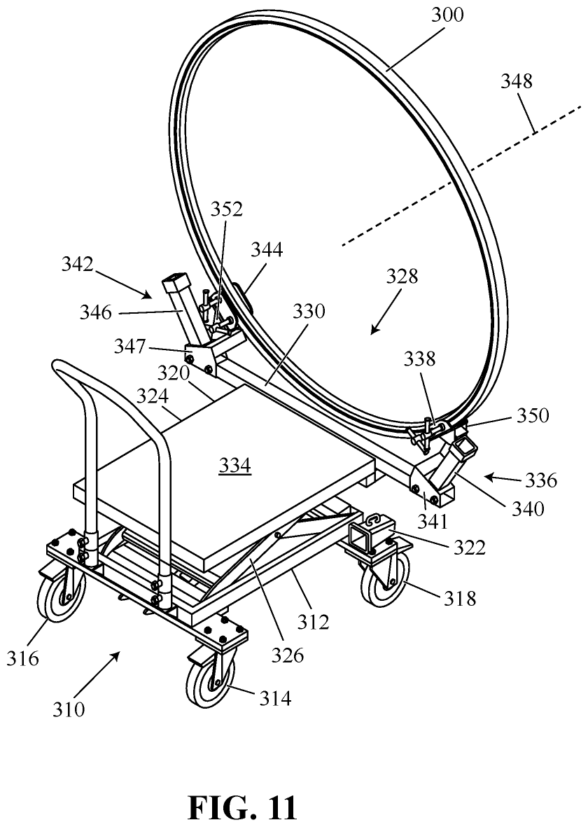

Another embodiment according to this disclosure is shown in FIG. 11 with respect to an apparatus 310 for manipulating a lock ring 300 for a wheel. Similar to lock ring 100, lock ring 300 may be a generally circular ring that is resiliently deformable, and shaped to have a non-deformed shape in the absence of external deforming force. In contrast to lock ring 100, lock ring 300 of FIG. 11 is not a split ring, although rings 100 and 300 may be used interchangeably with the apparatus described herein.

An apparatus according to one embodiment for manipulating the lock ring 300 is shown generally at 310. The elements of apparatus 310 may be similar to elements of apparatus 110, but within the 300 series of numbers. As shown in FIG. 11, for example, apparatus 310 may include a base 312 that is substantially similar to the base 112 shown in FIG. 1. Base 312 may include rear caster wheels 314 and 316, and front caster wheels 318 and 320. Similar to wheels 114, 116, 118, and 120, the wheels 314, 316, 318, and 320 (shown underneath table 334 in FIG. 11) may permit base 312 and thus apparatus 310 to move generally horizontally on a generally horizontal surface. For example, wheels 314, 316, 318, and 320 may include brakes and/or swivel relative to base 312, allowing apparatus 310 to move in different generally horizontal directions, similar to apparatus 110. Base 312 also may include first and second storage receptacles 322 and 324 (also show underneath table 334 in FIG. 11) that, like corresponding receptacles 112 and 124, may be used in storage. Apparatus 310 of FIG. 11 also may include a lift 326 that movably supports a lock ring support body 328 relative to the base 312. Lift 326 may include any lifting technology. For example, lift 326 of FIG. 11 is shown as a scissor lift similar to lift 126 and may include similar hydraulics.

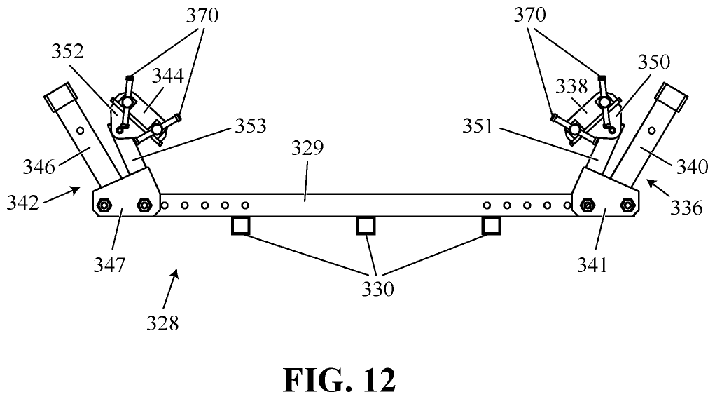

In the embodiment shown, lift 326 may movably support the lock ring support body 328 relative to base 312. For example, lock ring support body 328 may include: a lifting table or table 334; a first lock ring support 336 including a first support receptacle 338, a first catch arm receptacle 340, and a first support bar connector 341; and a second lock ring support 342 including a second support receptacle 344, a second catch arm receptacle 346, and a second support bar connector 347. As shown in FIG. 11, the first and second support receptacles 338 and 344 may support the lock ring 300 generally vertically while allowing the lock ring 300 to be rotated (manually or otherwise) about a generally horizontal axis 348 of the lock ring. As shown in FIG. 12, the first support receptacle 338 may be hinged to the first lock ring support 336 at a first hinge 350 attached to a first hinge support 351, and the second support receptacle 344 may be hinged to the second lock ring support 342 at a second hinge 352 attached to a second hinge support 353, to accommodate different diameters of lock rings.

As described above, apparatus 110 may include a winch 154 and strap 155 that secures lock ring 100 to the lock ring body 128, for example during movement of the apparatus 110. In the embodiments now described, the first and second support receptacles 338 and 344 may both support the lock ring 300 relative to the lock ring support body 328, and secure the lock ring 300 to the lock ring body 328, such that movement of the lock ring support body 328 causes movement of the lock ring 300. In these embodiments, similar to above, moving the base 312, and thus the apparatus 310 and the lock ring support body 328, generally horizontally on the caster wheels 314, 316, 318, and 320 causes corresponding generally horizontal movement of the lock ring 300 when ring 300 is supported in and/or secured by the first and second support receptacles 338 and 344 as shown in FIG. 11. Further, generally vertical movement of the ring support body 328 relative to the base 312 causes corresponding generally vertical movement of the lock ring 300 when ring 300 is supported in and/or secured by the first and second support receptacles 338 and 344, as also shown in FIG. 11.

Referring to FIG. 12, ring support body 328 may include a support bar 329. As shown, support bar 329 may include connectors 330 that are removably attachable to table 334. For example, an underside of table 334 of FIG. 11 may include bars extending outwardly therefrom, and each of the connectors 330 may include a receptacle configured to receive one of bars, allowing embodiments of support body 328 to be removably attached to and interchangeable with embodiments of table 334. The first and second lock ring supports 336 and 342 may be removably attached to the support bar 329. As shown in FIG. 12, for example, the first lock ring support 336 may be formed by assembling (e.g., welding) the first hinge support 351, the first catch arm receptacle 340, and the first support bar connector 341; and the second lock ring support 342 may be formed by assembling (e.g., welding) the second hinge support 353, the second catch arm receptacle 346, and the second support bar connector 347. The first lock ring support 336 may be removably attached to support bar 329 by the first support bar connector 341, and the second lock ring support 342 may be removably attached to the bar 329 by second support bar connector 347. For example, as shown in FIG. 12, the support bar 329 may include holes, and each of the first and second support bar connectors 341 and 347 may be removably attached to the support bar 329 at different positions by inserting bolts or locking pins through the holes, allowing the distance between the first and second lock ring supports 336 and 342 to be adjustable to accommodate different lock rings.

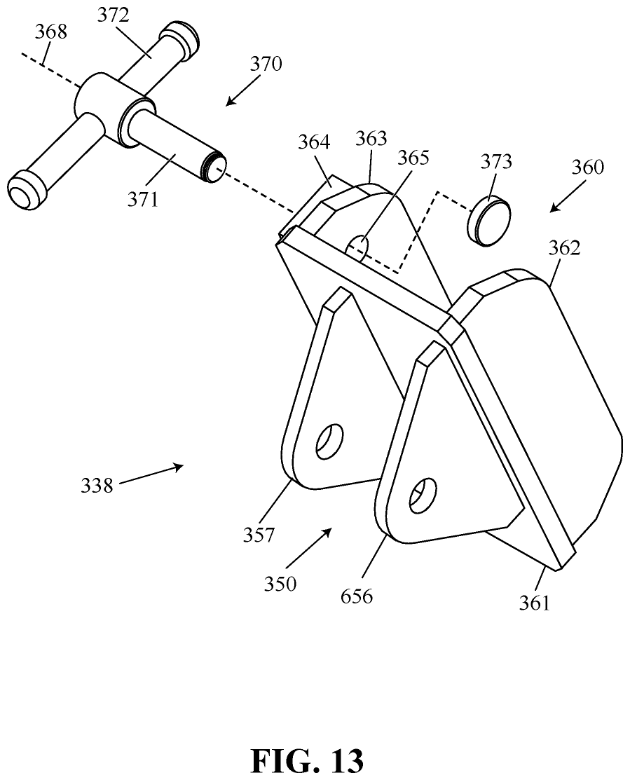

Additional aspects of the first and second support receptacles 338 and 344 are now described with reference to FIG. 13, which depicts an exemplary first support receptacle 338. As shown in FIG. 13, the first support receptacle 338 may include: a base plate 361, plates 362 and 363 extending outward from base plate 361 in one direction; and plates 356 and 357 extending outward from base plate 361 in an opposite direction. In this example, a support channel 360 may be defined between plates 362 and 363, and the first hinge 350 may be defined between plates 356 and 357. The second support receptacle 344 may be substantially the same as the first support receptacle 338. For example, second support receptacle 344 may include similar plates extending oppositely to define a second support channel and the second hinge 352. More generally, any number and/or arrangement of plates may define channels and hinges described herein.

As shown in FIGS. 11-13, each of the first and second support receptacles 338 and 344 may include one or more adjustment screws 370 operable to secure the lock ring 300 within the respective first and second support receptacles 338 and 334. As shown in FIG. 13, for example, the first support receptacle 338 may include one or more holes 365 extending into the first support channel 360 through plate 363, and one adjustment screw 370 may be retained in each hole 365. As shown in FIG. 13, each adjustment screw 370 may include a body 371, a grip bar 372, and a retainer 373. The grip bar 372 may intersect one end of the body 371. In FIG. 13, for example, a first end of body 371 includes a hole, and the grip bar 372 is mounted in the hole for movement relative to the first end of body 371. Each screw 370 may be retained in one of the holes 365 by retainer 373. For example, a second end of body 371 may be advanced into one of the holes 365 along an axis 368, and then attached (e.g., welded) to retainer 373 to retain screw 370 in the hole 365.

Various means for operating the adjustment screws 370 are contemplated. In some embodiments, the adjustment screws 370 may be rotated relative to the first and second support receptacles 338 and 344 to secure portions of the lock ring 300 therein. As shown in FIG. 13, or example, a threaded connection may be formed between a portion of each body 371 and a portion of each hole 365 so that rotation of body 371 about axis 368 (e.g., by application of a rotation force to grip bar 372) advances retainer 373 into support channel 360 along axis 368 until retainer 373 engages a portion of the lock ring 300, securing a first portion of lock ring 300 in channel 160. Second support receptacle 344 may be operable in a substantially similar manner to secure a second portion of lock ring 300. In FIG. 13, for example, each hole 365 extends through plate 363 and a thread plate 364 attached (e.g., welded) thereto, and a portion of hole 365 extending through the thread plate 364 may include threads engageable with body 371 of screw 370. More generally, the adjustment screws 370 may include any type of mechanical connection, threaded or non-threaded, configured to secure portions of the lock ring 300. For example, any type of geared, ratcheting, and non-rotational mechanical connection may be used.

Accordingly, referring to FIGS. 11-13, in one embodiment positioning a lock ring in a lock ring groove of a wheel with apparatus 310 may involve some or all of the following, and not necessarily in the following order:
1. fully lowering the lock ring support body 328;
2. removing first and second catch arms 400 and 402 (described below) from the lock ring support body 328;
3. attaching the first and second support receptacles 338 and 344 to the lock ring support body 328, for example with locking pins to attach the first and second support receptacles 338 and 344 to the lock ring support body 328;
4. applying one or more brakes on one or more of the caster wheels 314, 316, 318, and 320 to hold the apparatus 310 in position;
5. supporting the lock ring 300 in the first and second support receptacles 338 and 344;
6. when the lock ring 300 is supported in the first and second support receptacles 338 and 344, rotating the lock ring 300 into a desired position relative to support receptacles 338 and 344;
7. operating one or more adjustment screws 370 to secure the lock ring 300 in the first and second support receptacles 338 and 344;
8. releasing the one or more brakes, and moving the apparatus 310, and thus the lock ring 300, generally horizontally on the caster wheels 314, 316, 318, and 320 such that the lock ring 300 is proximate the wheel;
9. applying one or more brakes on one or more of the caster wheels 314, 316, 318, and 320 to hold the apparatus 310 in position;
10. adjusting a generally vertical height of the lock ring support body 328 relative to the base 312 to move the lock ring 300 generally vertically and proximate the wheel (in some embodiments this may involve moving the lock ring 300 generally vertically and into generally vertical alignment with the wheel such that the generally horizontal axis 348 of the lock ring 300 is substantially aligned with a corresponding horizontal axis of the wheel);
11. operating the one or more adjustment screws 370 to release the lock ring 300 from the first and second support receptacles 338 and 344;
12. when one or more brakes on one or more of the caster wheels 314, 316, 318, and 320 are applied, positioning the lock ring 300 in a lock ring groove of the wheel around the entire circumference of the wheel; and
13. after positioning the lock ring 300 in the lock ring groove of the wheel, releasing the brakes and moving apparatus 310 away from the wheel.

In some embodiments, the wheel may be a wheel of an off-the-road vehicle or of a haul truck, and the wheel may have a diameter from about 57 inches (or about 145 centimeters) to about 63 inches (or about 160 centimeters). Also similar to above, the lock ring 300 may be shaped to have a non-deformed shape in the absence of external deforming force, as shown in FIG. 11. For example, the non-deformed shape of the lock ring 300 may have a diameter that is equal to or smaller than a diameter of the lock ring groove of the wheel so that the resilient tendency of the lock ring 300 may hold the lock ring in the lock ring groove.

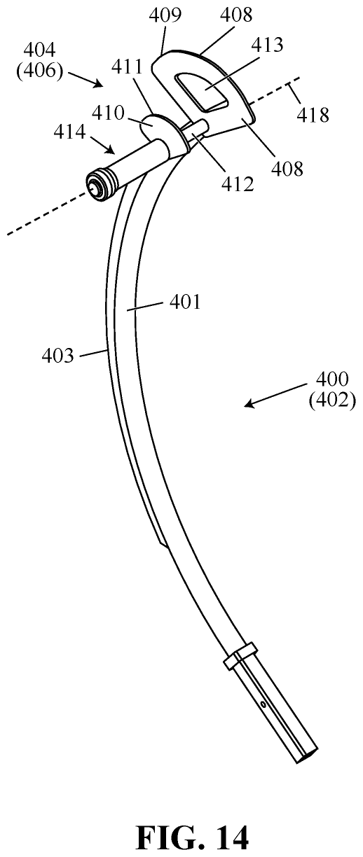

Similar to FIG. 6, the first catch arm receptacle 340 may receive a first catch arm 400, and the second catch arm receptacle 346 may receive a second catch arm 402. An exemplary first catch arm 400 is shown in FIG. 14 as including a first catcher receptacle 404, a body 401, and a spine 403 configured to reinforce the body 401. The first and second catch arms 400 and 402 may be substantially similar, like arms 200 and 202. Therefore, for ease of description, the second catch arm 402 is shown in FIG. 14 with a parenthetical reference number (402). Second catch arm 402 may include any element of first catch arm 400 described below.

As before, locking pins may attach the first and second catch arms 400 and 402 to the first and second catch arm receptacles 340 and 346 of the lock ring support body 328. Also as before, the first and second catch arm receptacles 340 and 346 and one end of the first and second catch arms 400 and 402 may have complementary square-shaped cross-sections, or more generally complementary non-circular cross-sections, to maintain the first and second catch arms 400 and 402 in defined positions and orientations relative to the lock ring support body 428. Also as above, the first and second catch arm receptacles 340 and 346 may support the first and second catch arms 400 and 402 relative to the lock ring support body 328 such that movement of body 328 causes movement of arms 400 and 402. For example, moving the base 312, and thus the apparatus 310 and the lock ring support body 328, generally horizontally on the caster wheels 314, 316, 318, and 320 may cause corresponding generally horizontal movement of the first and second catch arms 400 and 402 when supported in the first and second catch arm receptacles 340 and 346, similar to as shown in FIG. 6. Further, generally vertical movement of the lock ring support body 328 relative to the base 312 causes corresponding generally vertical movement of the first and second catch arms 400 and 402 when supported in the first and second catch arm receptacles 340 and 346. As shown in FIG. 14, spine 403 is configured to reinforce body 401 during these movements.

The first catch arm 400 may include the first catcher receptacle shown generally at 404, and the second catch arm 402 may include a second catcher receptacle shown generally at 406. Again, for ease of description, the second catch receptacle 406 is shown in FIG. 14 with a parenthetical reference number (406). Referring to FIG. 14, the first catcher receptacle 404 may include guide plates 408 and 410, and a catch body 412 extending between the plates 408 and 410. Similar to above, the guide plates 408 and 410 and the catch body 412 may receive, position, and/or hold a lock ring after being removed from a lock ring groove of a wheel. In contrast to above, guide plates 408 and/or 410 may be configured to align the lock ring with the wheel. As shown in FIG. 14, for example, guide plate 408 may have a triangular shape with a curved side 409, and guide plate 410 may have a triangular shape with a curved side 411. In this example, one corner of plates 408 and 410 may be coaxially aligned with an axis 418 of catch body 412 so that the respective curved sides 409 and 411 are curved about axis 418. In some embodiments, the curvature of sides 409 and 411 may be similar to a radius of a wheel, making it easier to align the lock ring with the wheel. As shown in FIG. 14, guide plate 408 may include a guide window 413 that provides a line of sight to the wheel.

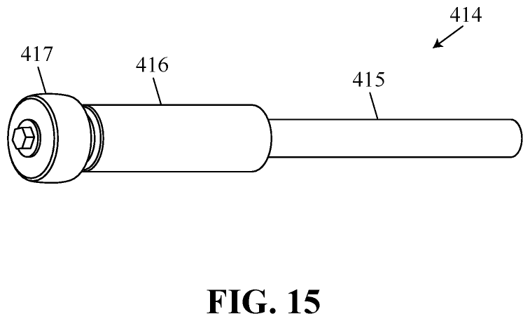

As shown in FIG. 14, a roller 414 may extend away from the first catcher receptacle 404. An exemplary roller 414 is shown in FIG. 15, in which roller 414 includes a roller body 415, a sleeve 416, and an end roller 417. For example, catch body 412 of FIG. 14 may include a lumen extending along axis 418, and one end of roller body 415 may be received in the lumen. Sleeve 416 may be on a mid-portion of roller body 415, and end roller 417 may be on an end of roller body 415. Each of roller body 415, sleeve 416, and end roller 417 may be made of different materials. For example, roller body 415 may be made of metal (e.g., aluminum, which may be knurled), sleeve 416 may be made of nylon, and end roller 417 may be made of rubber. End roller 417 may have a diameter greater than a diameter of roller body 415 and/or sleeve 416. As before, one or more surfaces of roller 414 and/or end roller 417 may be positioned against one or more surfaces of a wheel (similar to as shown in FIGS. 8 and 9, for example) to align the first or second catcher receptacles 404 and 406 relative to the wheel; and/or allow the first and second catcher receptacles 404 and 406 to center themselves on a top side of the wheel while being elevated against the top side of the wheel to, for example, accommodate for any misalignment of the apparatus 310 relative to the wheel. Furthermore, also as above, the end roller 417 may be received behind a surface of the wheel (similar to as shown in FIGS. 8 and 9, for example) to prevent the first catcher receptacle 404 from separating from the wheel. In alternative embodiments, the lock ring support body 328 may support one or more catcher receptacles in other ways, and one or more catcher receptacles may differ in alternative embodiments.

Referring to again FIGS. 8 and 9, a lock ring may be removed from a wheel 218, which may have an outer peripheral surface 220, and a pair of lock grooves 222 and 224 in the outer peripheral surface 220. For example, the lock grooves 222 and 224 may be sized to receive either lock ring 100 of FIG. 1 or lock ring 300 of FIG. 11. As before, the wheel 218 may have a first generally cylindrical inner surface 226, a second generally cylindrical inner surface 228, and a generally annular inner surface 230 extending between the first and second generally cylindrical inner surfaces 226 and 228.

In one embodiment, removing a lock ring from one of the lock grooves 222 or 224 of the wheel 218 with apparatus 310 may involve some or all of the following, and not necessarily in the following order:
1. fully lowering the lock ring support body 328;
2. removing the first and second support receptacles 338 and 344 from the ring support body 328;
3. attaching the first and second catch arms 400 and 402 to the first and second catch arm receptacles 340 and 346 of the lock ring support body 328, for example with locking pins to attach the first and second catch arms 400 and 402 to the first and second catch arm receptacles 340 and 346 of the lock ring support body 328;
4. moving the apparatus 310, and thus the first and second catch arms 400 and 402, generally horizontally on the caster wheels 314, 316, 318, and 320 and proximate the wheel 218;
5. applying one or more brakes on one or more of the caster wheels 314, 316, 318, and 320 to hold the apparatus 310 in position;
6. adjusting a generally vertical height of the lock ring support body 328 relative to the base 312 to move the first and second catch arms 400 and 402 such that, for example:
   a. an outer surface of the roller 414 contacts the second generally cylindrical inner surface 228, and an outer surface of the end roller 417 contacts the generally annular inner surface 230, to align the first catcher receptacle 404 to the wheel 218, and/or
   b. the second catcher receptacle 406 is aligned to the wheel 218 in substantially the same way;
7. operating one or more of the adjustment screws 370 to secure the lock ring in the first and second support receptacles 338 and 344;
8. removing the lock ring from one of the lock grooves 222 or 224 of the wheel 218; and
9. after removing the lock ring from the wheel 218, receiving the lock ring in the first and second catcher receptacles 404 and 406.

Similar to above, the lock ring may be removed from the lock groove using, for example, a lever, a pry-bar, or by another removing mechanism.

Apparatus 310 may be stored similar to apparatus 110. For example, similar to as shown in FIG. 10, the apparatus 310 may be stored by storing the first catch arm 400 in the storage receptacle 324, and the second catch arm 402 in storage receptacle 322.

In general, embodiments such as those described herein may facilitate manipulating a lock ring such as the lock ring 300. For example, the apparatus 310 may facilitate holding, positioning, and/or receiving lock ring 300 while positioning the ring 300 in one of the lock grooves 222 or 224 of wheel 218 and/or removing the ring 300 from said groove 222 or 224, for example as described above. In some embodiments, apparatus 310:
1. may be configured for positioning a lock ring in a lock ring groove of a wheel by removing the first and second catch arms 400 and 402, and by attaching the first and second support receptacles 338 and 344 to the lock ring support body 328; and
2. may be configured for removing a lock ring from a lock ring groove of a wheel by removing the first and second support receptacles 338 and 344 from the lock ring support body 328, and by attaching the first and second catch arms 400 and 402 to the first and second catch arm receptacles 340 and 346 of the lock ring support body 328;
   so that embodiments such as the apparatus 310 may be converted to one of different but potentially related purposes of positioning a lock ring in a groove of a wheel and removing a lock ring from a groove of a wheel.

Commercial embodiments may again include kits or systems including one or more apparatuses such as those described above, and apparatuses, kits, and systems such as those described above may be offered commercially for use in positioning a lock ring in a groove of a wheel and/or removing a lock ring from a groove of a wheel, for example as described above.

Embodiments such as those described herein may controllably hold a lock ring while positioning the ring in a groove of a wheel, and/or while removing the ring from a groove of a wheel. Because of apparatus 310, holding and controlling the lock ring may require less human effort, may be less challenging, and/or may be less dangerous when compared to other ways of positioning a lock ring in a groove of a wheel and/or removing the lock ring from a groove of a wheel.

Although specific embodiments have been described and illustrated, such embodiments should be considered illustrative only and not as limiting the invention as construed according to the accompanying claims.

1. A method of manipulating a lock ring for a wheel, the method comprising:
increasing a separation distance between a first fastener fastened to a first end of the lock ring and a second fastener fastened to a second end of the lock ring opposite the first end.

2. The method of claim 1 further comprising fastening the first and second fasteners to the first and second ends respectively of the lock ring.

3. The method of claim 2 wherein fastening the first fastener to the first end of the lock ring comprises clamping the first fastener to the first end of the lock ring.

4. The method of claim 2 or 3 wherein fastening the second fastener to the second end of the lock ring comprises clamping the second fastener to the second end of the lock ring.

5. The method of claim 2, wherein fastening the first fastener to the first end of the lock ring comprises positioning a retaining surface of the first fastener against an end surface of the first end of the lock ring.

6. The method of claim 2, wherein fastening the second fastener to the second end of the lock ring comprises positioning a retaining surface of the second fastener against an end surface of the second end of the lock ring.

7. The method of claim 1 wherein increasing the separation distance comprises causing motion of a ratchet to transfer force to the first and second fasteners.

8. The method of claim 1 further comprising guiding motion of the first and second fasteners relative to each other in a generally axial direction of the lock ring.

9. The method of claim 8 further comprising restricting a range of motion of the first and second fasteners relative to each other in the generally axial direction of the lock ring.

10. The method of claim 1 further comprising:
decreasing the separation distance between the first and second fasteners after increasing the separation distance; and
positioning the lock ring in a lock ring groove of the wheel while decreasing the separation distance.

11. The method of claim 10 further comprising causing a lock ring positioner to position the lock ring proximate the wheel before positioning the lock ring in the lock ring groove of the wheel.

12. The method of claim 10 further comprising:
causing a lock ring positioner to position the lock ring proximate the wheel before positioning the lock ring in the lock ring groove of the wheel.

13. The method of claim 11 wherein causing the lock ring positioner to position the lock ring proximate the wheel comprises supporting the lock ring in a generally vertical orientation while allowing the lock ring to be rotated about a generally horizontal axis of the lock ring.

14. The method of claim 1 further comprising:
maintaining the separation distance after increasing the separation distance; and
removing the lock ring from the wheel while maintaining the separation distance.

15. The method of claim 14 further comprising receiving the lock ring in at least one catcher receptacle of a lock ring positioner after removing the lock ring from the wheel.

16. The method of claim 1 further comprising:
receiving the lock ring in at least one catcher receptacle of a lock ring positioner after removing the lock ring from the wheel.

17. The method of claim 15 or 16 further comprising aligning the at least one catcher receptacle relative to the wheel before receiving the lock ring in the at least one catcher receptacle.

18. The method of claim 17 wherein aligning the at least one catcher receptacle relative to the wheel comprises positioning at least one alignment surface against a portion of the wheel.

19. The method of claim 18 wherein positioning the at least one alignment surface against the portion of the wheel comprises positioning at least one roller against the portion of the wheel.

20. The method of claim 18 wherein positioning the at least one alignment surface against the portion of the wheel comprises positioning the at least one alignment surface against an inner surface of the wheel.

21. The method of claim 12, further comprising moving at least a portion of the lock ring positioner generally horizontally to move the lock ring generally horizontally.

22. The method of claim 12, further comprising moving at least a portion of the lock ring positioner generally vertically to move the lock ring generally vertically.

23-32. (canceled)

33. An apparatus for manipulating a lock ring for a wheel, the apparatus comprising:
a first fastener configured to be fastened to a first end of the lock ring;
a second fastener configured to be fastened to a second end of the lock ring opposite the first end of the lock ring; and
a spreader coupled to the first and second fasteners and configured to increase a separation distance between the first and second fasteners when the first and second fasteners are fastened to the first and second ends respectively of the lock ring.

34. The apparatus of claim 33 wherein the first fastener comprises a clamp configured to clamp the first end of the lock ring to fasten the first fastener to the first end of the lock ring.

35. The apparatus of claim 33 wherein the second fastener comprises a clamp configured to clamp the second end of the lock ring to fasten the second fastener to the second end of the lock ring.

36. The apparatus of claim 33, wherein the first fastener comprises a retaining surface configured to be positioned against an end surface of the first end of the lock ring when the first fastener is fastened to the first end of the lock ring.

37. The apparatus of claim 33, wherein the second fastener comprises a retaining surface configured to be positioned against an end surface of the second end of the lock ring when the second fastener is fastened to the second end of the lock ring.

38. The apparatus of claim 33 wherein the spreader comprises a linear translator configured to separate the first and second fasteners generally linearly from each other to increase the separation distance between the first and second fasteners.

39. The apparatus of claim 33 wherein the spreader comprises a ratchet configured to transfer force to the first and second fasteners to increase the separation distance between the first and second fasteners.

40. The apparatus of claim 33 wherein the first fastener is rotatable relative to the spreader generally about a first radial axis of the lock ring and the second fastener is rotatable relative to the spreader generally about a second radial axis of the lock ring to permit the first and second fasteners to move relative to each other in a generally axial direction of the lock ring.

41. The apparatus of claim 40 wherein rotation of the first fastener relative to the spreader is restricted to restrict a range of motion of the first and second fasteners relative to each other in the generally axial direction of the lock ring.

42. The apparatus of claim 41 wherein rotation of the second fastener relative to the spreader is restricted to restrict a range of motion of the first and second fasteners relative to each other in the generally axial direction of the lock ring.

43. The apparatus of claim 33 wherein the spreader is further configured to allow the separation distance between the first and second fasteners to decrease to position the lock ring in a lock ring groove of the wheel while decreasing the separation distance.

44. An apparatus for positioning a lock ring relative to a wheel, the apparatus comprising:
at least one receptacle configured to hold the lock ring;
wherein the at least one receptacle is movable proximate the wheel;
wherein the least one receptacle comprises at least one support receptacle configured to support the lock ring to position the lock ring in a lock ring groove of a wheel; and
wherein the at least one support receptacle is movable to position the lock ring proximate the wheel before positioning the lock ring in the lock ring groove of the wheel.

45. (canceled)

46. The apparatus of claim 44 wherein the at least one support receptacle is configured to support the lock ring in a generally vertical orientation while allowing the lock ring to be rotated about a generally horizontal axis of the lock ring.

47. The apparatus of claim 46 wherein:
the least one receptacle comprises at least one catcher receptacle configured to receive the lock ring after removing the lock ring from the wheel; and
the at least one catcher receptacle is movable proximate the wheel to receive the lock ring when the lock ring is removed from the wheel.

48. The apparatus of claim 47 further comprising at least one alignment surface positionable against a portion of the wheel to align the at least one catcher receptacle relative to the wheel before receiving the lock ring in the at least one catcher receptacle.

49. The apparatus of claim 48 further comprising at least one roller comprising the at least one alignment surface.

50. The apparatus of claim 49 wherein the at least one receptacle is movable generally vertically to move the lock ring generally vertically when the at least one receptacle holds the lock ring.

51. The apparatus of claim 50 wherein the at least one receptacle is movable generally horizontally to move the lock ring generally horizontally when the at least one receptacle holds the lock ring.

52-57. (canceled)
